(19) United States
(12) Patent Application Publication
(10) Pub. No.: US 2014/0302206 A1
(43) Pub. Date: Oct. 9, 2014

(54) Microwave Vacuum Process For Making An Infusion From Natural Products

(71) Applicant: Timothy M. Niemiec, Chicago, IL (US)

(72) Inventor: Timothy M. Niemiec, Chicago, IL (US)

(21) Appl. No.: 13/859,085

(22) Filed: Apr. 9, 2013

(51) Int. Cl. A23L 3/54; A23B 7/01; A23B 4/01; A23L 1/317; A23L 1/20; A23L 1/22; A23L 1/325; A23L 1/214; A23L 1/212; A23L 1/314

(52) U.S. Cl. CPC A23L 3/54; A23L 1/2123; A23B 7/01; A23B 4/01; A23L 1/314; A23L 1/2005; A23L 1/22; A23L 1/3255; A23L 1/214; A23L 1/317
USPC 426/242; 426/241; 426/615; 426/646; 426/641; 426/634; 426/638; 426/643

(57) ABSTRACT

The present invention provides novel and improved processes designed for dehydrating natural products and creating a liquid infused with the dehydrated natural products. The process comprises the steps of selecting a natural product out of which to create the infusion. Once selected the natural product is then dehydrated to a moisture content of 10-25%. Following the dehydration step, the natural product is placed in a microwave vacuum device for additional dehydration under negative pressure and elevated temperature between 120-220 degrees Fahrenheit. Following the microwave vacuum step, the natural product is rapidly cooled to between 36-60 degrees Fahrenheit. The cooled natural product is then granulated or ground to improve its suitability for infusion. To make the infusion, the ground or granulated natural product is exposed to a liquid.

### BACKGROUND

This invention relates to a method for producing an infusion from a natural starting product. The infusion may be used for any purpose desired and the inventor specifically contemplates use as a beverage and a stock/broth or as an ingredient or additive. Infusions such as teas and broths, are popular products as they bring the flavors and nutrients of natural products such as fruits, vegetables, herbs, spices and meats into a convenient form. There is a significant difference in both flavor profile as well as nutritional content between fresh natural products and commercially available natural products. Fresh natural products also have a limited shelf life. The most successful commercial technique for extending the shelf life of natural products is air drying. Unfortunately the drying process substantially alters the flavor profile of the natural products and results in deterioration in the products' nutrients.

A number of other methods have been proposed for drying natural products such as fruits, vegetables, herbs, spices and the like. Many of these processes have the unintended consequence of altering the flavor and nutritional profile of the natural product. For example, oil-frying has the disadvantage that the oxidation of the oil deteriorates the flavor of the product and adversely affects the taste of the product. Additionally, frying introduces fat into the product and will result in a product unsuitable for liquid infusion as the fat will not mix with an aqueous solution.

Freeze drying also has numerous disadvantages. One such disadvantage is that the freeze-drying process takes a long time. The result of the need for the extended time is that the process becomes expensive. Vacuum drying has the disadvantage that the resulting natural product has a reduced bulk, rather than a porous structure which can make it unsuitable for use in an infusion.

Heat-drying using microwave energy is an attractive solution to a variety of reasons. In microwave drying, heat is generated through the direct transformation of electromagnetic energy into kinetic energy. Thus, the heat is generated deep within the material to be dried. This is especially the case in vacuum drying where the penetrating effects of the microwave radiation can be used to bulk dry viscous products with low thermal conductivity. As compared to conventional drying methods, microwaves offer the following advantages: temperatures are higher on the inside than on the outside which gives rise to a higher partial pressure that drives liquid to the surface and enhances evaporation, as a consequence, the surfaces remain permeable, high drying velocity due water inside the product is selectively heated due to the greater dielectric losses of water compared to the product to be dried, swift and thorough drying of moist products with low thermal conductivity, stationary drying of thick layers, high efficiency of energy application, high-speed control of the energy transport, and short processing times suitable for automation.

When performed in a vacuum, microwave heating has additional advantages, for example: low drying temperatures, no oxygen to attack the product, highly nutritious properties, better flavor, less hydroscopic final product, minimal product losses, and static drying of thick layers without fractional losses, therefore, no mechanical stress for the product.

### SUMMARY

The present invention provides novel and improved processes designed for dehydrating natural products and creating a liquid infused with the dehydrated natural products. Depending on the natural product used in the infusion, the infusion may be suitable as a cold beverage, a hot beverage, a broth, or a stock. The process comprises the steps of selecting a natural product out of which to create the infusion. Once selected the natural product should be washed or otherwise cleansed in order to remove any impurities. Where the natural starting product is large it should be cut or broken up into smaller pieces to maximize surface area which will enhance the further processing steps. The natural product is then dehydrated to a moisture content of 10-25%. Typically a commercially available food dehydrator will be used for this step. Following the dehydration step, the natural product is placed in a microwave vacuum device for additional dehydration under negative pressure and elevated temperature between 120-220 degrees Fahrenheit. This step extracts additional moisture and maintains taste and vitamin integrity while creating a crisp, puffed natural product suitable for additional processing. The microwave vacuum step reduces the moisture content in the natural product to between 0-10%. Following the microwave vacuum step, the natural product is rapidly cooled to between 36-60 degrees Fahrenheit. The cooled natural product is then granulated or ground to improve its suitability for infusion. To make the infusion, the ground or granulated natural product is exposed to a liquid. Typically, the liquid will be heated to a between 180-210 degrees Fahrenheit.

### BRIEF DESCRIPTION OF THE DRAWINGS

FIG. 1: shows a flow diagram illustrating the various steps of the process

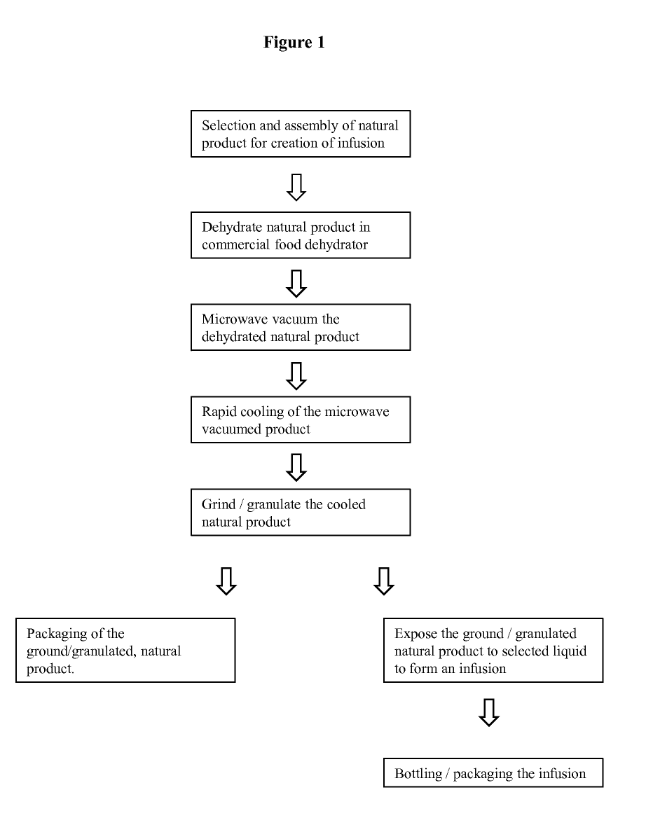

### DETAILED DESCRIPTION

The following detailed description is of the best currently contemplated modes of practicing the invention. The description is not to be taken in a limiting sense, but is made merely for the purpose of illustrating the general principles of the invention since the scope of the invention is best defined by the appended claims.

The process begins with the selection and assembly of a natural product, out of which the infusion will be made. The product should use naturally occurring ingredients in their naturally occurring state. The natural product should not be fried, have added sugar, preservatives, artificial coloring or sulfur compounds. The natural starting product could be any fruit, vegetable, herb, spice, berry, legume, leaf, meat, meat product, fish, sausage, or other appropriate natural product. The selected product should be divided up into smaller pieces to increase surface area and improve dehydration characteristics. The dividing can be done by any method known to those skilled in the art including slicing, cutting, chopping and the like.

The selected natural product is then put through a process of dehydration. The dehydration step can be done using any method known to those skilled in the art. For example, by using a commercially available food dehydrator. A commercial food dehydrator's basic parts usually consist of a heating element, a fan, air vents allowing for air circulation and food trays to lay food upon. A dehydrator's heating element, fans and vents simultaneously work to remove moisture from food. A dehydrator's heating element warms the food causing its moisture to be released from its interior. The appliance's fan then blows the warm, moist air out of the appliance via the air vents. This process continues until the food is dried to a substantially lower water content. The dehydration process should continue until the natural product has a moisture content of between 10-25%, particularly to a moisture content of 10-20% and more particularly 14-16% moisture.

Meat and sausage should be cooked already in some fashion for example smoked or heated as in, for example, baked, fried, sautéed, grilled or broiled. Meat and sausage product may not need the 1st dehydration step, however it may be desirable.

The dehydrated natural product is then microwave vacuumed to further reduce its moisture content. Before placement into the microwave vacuum device, the natural product may be placed in a perforated drum. The microwave vacuum extracts moisture and heats the product to pull off and cook the raw natural product. The microwave vacuum step further comprises running the vacuum to reduce the pressure inside the vacuum microwave for approximately 5-90 seconds. During this initial vacuuming step the microwave aspect turns on and provides microwave energy for approximately 90-150 seconds, particularly 110-140 seconds. The internal temperature of the microwave while it is running is approximately 50-60 degrees centigrade. After the microwave aspect turns off the vacuum continues to run and pull moisture from the product. This is called the rest period and lasts between 120-300 seconds and particularly 180-300 seconds. The total microwave vacuum process may last between 360-600 seconds, and particularly 480-600 seconds. The microwave vacuum process should reduce the moisture level in the natural product to between 0-10%, particularly 3% or less and particularly 2% or less.

Coming out of the microwave vacuum the natural product is rapidly cooled. The cooling may be accomplished by any method known to those skilled in the art. Including, a refrigerator, cooling tunnel, blast chiller or the like. For example, the product is moved to a cooling box or chamber containing cold, dry air. The air should be between 40-50 degrees Fahrenheit, and particularly between 44-46 degrees Fahrenheit. The natural product should remain in the cooling box or chamber for between 20-150 seconds and particularly between 90-120 seconds. Humidity in the cooling box or chamber should be between 40-50% and particularly 45%. The natural product can be stored at this temperature before further processing or packaging.

After the cooling step, the natural product is ground or granulated. For the purposes of this process the terms ground and granulated are used interchangeably. Any grinding/granulating process known to those skilled in the art may be appropriate. As in, for example a coffee grinder. For natural products that are soluble, a smaller grind size may be appropriate. For natural products to be used in a filtration or steeping process, larger grind sizes may be appropriate.

The ground/granulated product can now either be packaged for later use or introduced to a liquid for the purposes of making an infusion. If packaged, the ground product should be packaged in an air-free environment. For example, in a vacuum sealed package or under an inert gas such as nitrogen or argon. Additionally, the ground/granulated product may be used as an ingredient in other products or may be encapsulated, as in, for example, a gelatin capsule and distributed as a nutritional or herbal supplement.

To make the infusion the ground/granulated product is introduced to a liquid. This can be done by any method known to those skilled in the art, as in, for example by first placing the ground/granulated product into a permeable container such as a mesh bag or filter paper. Once in the permeable container, the container can be placed into a heated liquid to form the infusion. Alternatively the infusion can be made by pouring the heated liquid over the ground natural product. Typically, the liquid will be heated to between 180-210 degrees Fahrenheit. For some products, it may be desirable to do the infusion at a lower temperature such as room temperature or specifically between about 60-150 degrees Fahrenheit. Alcohol extractions/infusions may benefit particularly from this cooler temperature. The heated liquid may be water, alcohol, or any combination thereof or any other liquid into which an infusion is desired. In addition to heated liquids, Once made, the infusion can be bottled or otherwise packaged or consumed. The infusions may be consumed hot or cold.

With respect to the above, it is to be understood that the invention is not limited in its application to the details of construction and to the arrangement of the components listed or the steps set forth in the description or illustrated in the drawings. The various apparatus and methods of the disclosed invention are capable of other embodiments, and of being practiced and carried out in various ways that would be readily known to those skilled in the art, given the present disclosure. Further, the terms and phrases used herein are for descriptive purposes and should not be construed as in any way limiting.

As such, those skilled in the art will appreciate that the conception upon which this disclosure is based by be utilized as a basis for designing other inventions with similar properties. It is important therefore that the embodiments, objects, and claims herein, be regarded as including such equivalent construction and methodology insofar as they do not depart from the spirit and scope of the present invention.

It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

1. A process comprising the steps of:
assembling a quantity of a natural product;
dehydrating the natural product;
microwave vacuuming the dehydrated natural product;
cooling the microwave vacuumed dehydrated natural product; and
grinding or granulating the microwave vacuumed dehydrated natural product.

2. The process of claim 1 further comprising the step of exposing the ground or granulated microwave vacuumed dehydrated natural product to a liquid to form an infusion.

3. The process of claim 1 further comprising the step of dividing the natural product into smaller pieces.

4. The process of claim 2 where the liquid is heated to between 180-210 degrees Fahrenheit.

5. The process of claim 1 where the microwave vacuuming lasts 360-600 seconds.

6. The process of claim 1 where the natural product is dehydrated to a moisture content of 10-20%.

7. The process of claim 1 where the natural product is dehydrated to a moisture content of 14-16%.

8. The process of claim 1 where the natural product is selected from the group consisting of fruits, vegetables, berries, roots, herbs, spices, legumes, meat, meat products, and fish.

9. The process of claim 1 where the dehydrating step is performed in a food dehydrator.

10. The process of claim 1 where the microwave vacuuming step reduces the moisture content in the dehydrated natural product to 0-10%.

11. The process of claim 1 where the microwave vacuuming step reduces the moisture content in the dehydrated natural product to less than 3%.

12. The process of claim 1 where the microwave vacuuming step heats the dehydrated natural product to 150-220 degrees Fahrenheit.

13. The process of claim 1 where the microwave vacuuming step heats the dehydrated natural product to 122-140 degrees Fahrenheit.

14. The process of claim 1 where the dehydrated natural product is placed in a perforated polypropylene drum before microwave vacuuming.

15. The process of claim 1 where the vacuum microwaving step further comprises the steps of:
vacuuming for 5-90 seconds;
contemporaneous with the vacuuming, microwaving for 90-150 seconds; and
vacuuming for 120-300 seconds after the microwaving has ceased.

16. The process of claim 1 where the cooling step takes place in a chamber with a temperature of 40-50 degrees Fahrenheit and humidity between 40-50%.

17. The process of claim 1 further comprising the step of packaging the ground or granulated microwave vacuumed dehydrated natural product in a package containing no air.

18. The process of claim 17 where the ground or granulated microwave vacuumed dehydrated natural product is packaged in a container containing an inert gas.

19. An infusion prepared by a process comprising the steps of:
assembling a quantity of a natural product;
dehydrating the natural product;
microwave vacuuming the dehydrated natural product;
cooling the microwave vacuumed dehydrated natural product;
grinding or granulating the microwave vacuumed dehydrated natural product; and
exposing the ground or granulated microwave vacuumed dehydrated natural product to a heated liquid.

20. A natural product suitable for infusing into a liquid, the natural product prepared by a process comprising the steps of:
assembling a quantity of a natural product;
dehydrating the natural product;
microwave vacuuming the dehydrated natural product;
cooling the microwave vacuumed dehydrated natural product;
and
grinding or granulating the microwave vacuumed dehydrated natural product.
